(19) United States
(12) Patent Application Publication
(10) Pub. No.: US 2013/0186060 A1
(43) Pub. Date: Jul. 25, 2013

(54) Piecemeal Turbojet

(71) Applicant: Patrick A. Kosheleff, Yankee Hill, CA (US)

(72) Inventor: Patrick A. Kosheleff, Yankee Hill, CA (US)

(21) Appl. No.: 13/374,870

(22) Filed: Jan. 20, 2012

(51) Int. Cl. F02K 3/00

(52) U.S. Cl. 60/224

(57) ABSTRACT

A two-spool turbojet built up of major bladed components first developped for unrelated turbofan engine types. The high pressure (“HP”) spool comes from a turbofan which powered a large airliner carrying 300 or more passengers across a continent or an ocean. The low pressure (“LP”) compressor is the fan from a military aircraft's engine or a smaller airliner turbofan, or both. The object is that all the LP compressor output goes into the HP compressor, making a turbojet from existing turbofan components. This saves development costs, and creates an engine for propelling a large aircraft at supersonic speeds more efficiently than by an afterburning turbofan. In the preferred embodiment, the number of stages in the HP spool is halved, saving weight for the addition of a remote fan (known elsewhere) which doubles the air mass flow. That increases propulsive efficiency during subsonic cruise.

### BACKGROUND OF THE INVENTION

A turbojet of conventional design but using major parts from existing engines. The high pressure (“HP”) spool uses blading from a large turbofan and the low pressure (“LP”) spool uses blading from a small turbofan. Prior examples were not encountered in the art. The advantage expected here is that these major components are already developped, for reduced cost. Known turbojet low propulsive efficiency is an issue. Turning a remote fan by a driveshaft from the front of the turbojet is deemed useful. U.S. Pat. No. 3,161,019 shows such an arrangement in its FIG. 10.

### SUMMARY OF THE INVENTION

A turbojet including major parts from several existing turbofan engines. The object is to save much of the development cost and time of a new turbojet for a special purpose. Turbofan engines come in two kinds. The high-bypass kind is used in large subsonic airliners which can carry 300 or more passengers across a continent or an ocean. The second kind is much smaller and is found in small airliners or high-speed military aircraft. Their fans are proportionally small too, typically 3-4 feet instead of 8 feet in diameter. Blading adapted from a turbofan of the second kind will be used in the LP compressor of our turbojet engine.

The invention starts with an existing large airliner turbofan of bypass ratio about 5:1 and developping 40,000 lbs of thrust or more at takeoff. Such engines appeared in the 1970s and are widely used. Everything but the HP core is discarded. The HP core itself includes an 11-stage or more HP compressor and a 2-stage HP turbine driving the HP compressor. Of all that, only the outer half is kept: The first six stages of the HP compressor and the second stage of the HP turbine. That forms the “HP core” of our turbojet, which doesn't need a very high compression ratio.

The LP spool includes an LP compressor and an LP turbine. The LP compressor is adapted from fan blading found in turbofan engines of the second kind. In some of these small turbofans, the fan blading is the right size so that all its ultimate output (after more stages) enters the HP compressor cleanly, subject to that flow matching.

The LP turbine is not planned as an adaptation of an existing turbine, therefore may be developped from scratch. All these parts are connected conventionally as a two-spool turbojet. The result is a turbojet engine which has about the same maximum thrust, but without afterburning, as the military turbofan engine which powered a bomber capable of Mach 2.0. At Mach 2, a simple turbojet cycle is known to be more efficient than a turbofan with afterburning because the fuel is burned at a higher pressure ratio than in a jet pipe. Our turbojet would cut fuel use at Mach 2 by a signinficant amount, extending the range for some missions. But there is a drawback.

Turbojets are less efficient than turbofans in subsonic flight. There is too little air mass flow in the exhaust jet and it is at an excessive velocity. It can be remedied by adding a remote fan to double the air mass flow. This is already known in the art. Powering the remote fan by a driveshaft from the front of the turbojet is also known. A clutch at the connection restricts the remote fan use to subsonic flight. These features are incorporated or implied in the present invention.

The preferred embodiment includes a two-stage LP turbine for enough power to turn the remote fan. Added stages in the LP compressor increase the pressure ratio for more cycle efficiency and still more power. Increased pressure ratio means decreased volume flow, which is no longer matched to the inlet of the HP compressor. Volume flow is restored by enlarging all the stages in the LP compressor. A more economical alternative is to move the previously adopted first two stages of the existing small turbofan to stages 2 and 3 of our LP compressor. They are then preceded by the first stage of a different, slightly larger existing turbofan. Examples are given. Thus, the first three stages of our five-stage LP compressor are based on parts currently in use, thereby reducing development costs.

### BRIEF DESCRIPTION OF THE VIEWS

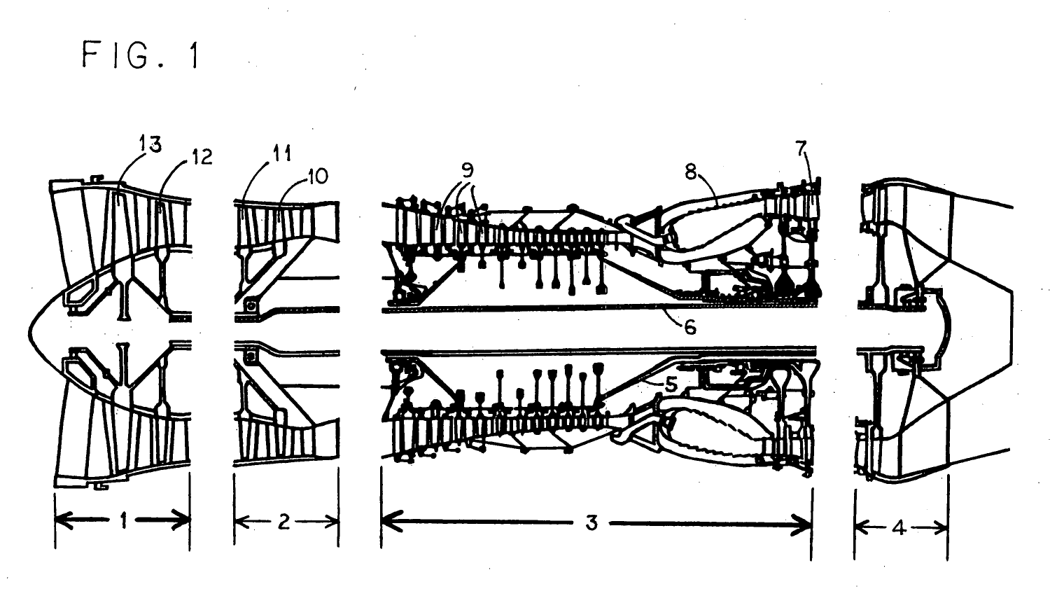

FIG. 1 is a lengthwise segmented view of a turbojet design incorporating major parts from current turbofan engines.

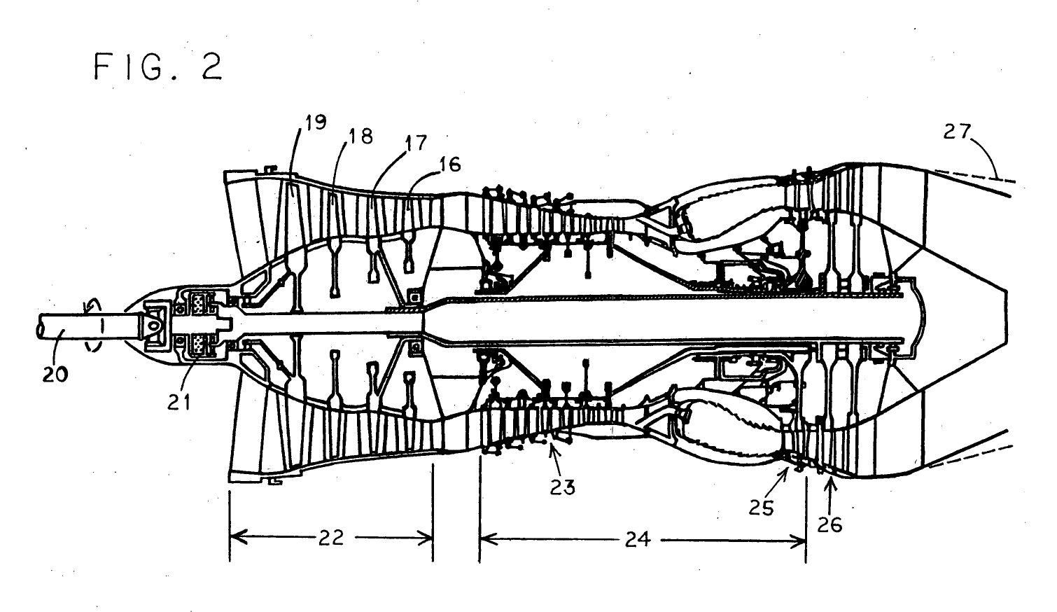

FIG. 2 is a shortened version of the turbojet and able to turn a remote fan of a type known in the art.

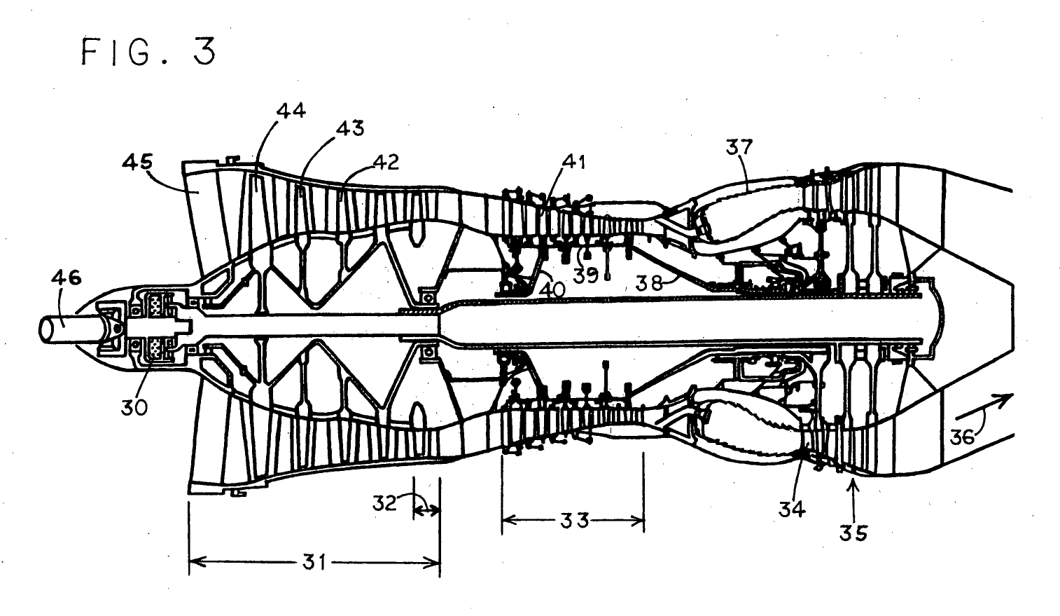

FIG. 3 shows a more powerful version of FIG. 2 configured to be the preferred embodiment.

### DETAILED DESCRIPTION

FIG. 1 shows the interior of a turbojet engine design. The engine is built up from four sections. There is a two-stage front fan 1, a two-stage booster 2, a complete high pressure core 3, and a low pressure turbine section 4. Sections 1 and 2 add up to a low pressure (“LP”) compressor. This engine is a two-spool engine, with items 5, 7 and 9 being part of the high pressure (“HP”) spool, and items 4, 6 and 10-13 being part of the LP spool. Thus, the general layout of our engine is similar to that of other two-spool turbojets going back to the original one, the J-57 dating from 1953. The difference is that in our engine the major parts 1 and 3 are taken from turbofan engine types which already reached production or prototype status.

The main consideration here is that the whole HP core 3 comes from a large airliner turbofan engine, in this case the well-known JT9D turbofan. Similarly, front fan 1 comes from a military turbofan engine (of low bypass ratio.) In this embodiment, components 1 and 3 are simply lifted from their usual role and adapted with minimum changes to work together as a derivative engine. Such piecemeal construction with known parts will save money on the way to attaining a new application.

Justifying the method uses a statement by an employee of the Gas Institute, “ . . . development of an entirely new gas turbine is very expensive and takes a long time.” (Journal of Engineering for Gas Turbines and Power, October 1992, Vol. 114, page 683.) One question might be, why is a new turbojet needed at all? The answer is that a potentially useful variation may be obtained in the mission profile of a bomber capable of Mach 2 speed.

FIG. 1 shows the method but is far from the final version. With the exception of the LP shaft 6, the whole component 3 is just the HP core of the JT9D large airliner turbofan engine. FIG. 1 can be compared to representations of the JT9D in the patent literature. In U.S. Pat. No. 5,622,045, its FIG. 1 shows a lengthwise cutaway of the JT9D. Its HP spool 35 corresponds to our HP spool 5; its HP compressor rotor blades 36a correspond to our HP compressor rotor blades 9, and its HP turbine blade 37 corresponds to our HP turbine blade 7. Its combustion chamber 39 corresponds to our combustion chamber 8; and so on. The drawing in our FIG. 1 conforms closely to the cutaway drawing of the HP core of JT9D at the bottom of page 747, JANE's All the World's Aircraft (hereafter, “JANE's”) 1978-79 issue. A more recent drawing of the enhanced JT9D, the PW4000, is seen on page 793 of 1998-99 JANE's.

Several other US Patents include useful detail. FIG. 1 of U.S. Pat. No. 4,513,567 shows the outer surface of JT9D. The big fan duct is at the left. HP compressor 12, combustion chamber 14, and HP turbine section 16 correspond to our components 9, 8 and 7. Part of their surface skin is broken away, showing HP turbine disk 22 and an HP compressor disk 24. The latter is seen as HP compressor disks 43 in U.S. Pat. No. 4,576,547, where the nine stages shown are the last nine stages of the actual 11-stage HP compressor in JT9D. Clearly this component is a large part of the whole engine. In our FIG. 1, adding the HP shaft 5 and HP turbine stages, e.g., 7 to complete the rotating HP spool verifies that it is a complex and expensive part that is worth re-using in a new role.

In the present document the main focus is on adapting the HP core from JT9D to our turbojet engine design. The savings represented by this approach can be gauged from a comment by authors considering modifying the Olympus 593 turbojet which powered the Mach 2 Concorde airliner (page 11 of Paper 760891, Society of Automotive Engineers (“SAE”), 1976): “ . . . the immense advantage, in terms of development timescale and cost, of using an HP spool that will have built up a vast background of service experience . . . ” That describes the JT9D, which has been in airline use for decades.

In FIG. 1, two-stage front fan 1 can be recognized as the front fan of the F101 turbofan which powers the B-1 bomber. This aircraft can fly at supersonic speeds. The F101's first fan stage is much smaller than JT9D's front fan. In other words, F101 has a small bypass ratio compared to JT9D (2:1 versus 5:1.) A cutaway view of the F101 engine is seen in silhouette as FIG. 6 of SAE Paper 720841 (also printed in bound SAE Transactions, Vol. 81, page 2520, 1972; call number TL1.S6.) A detailed view of F101's front fan is seen in FIG. 3 of SAE Paper 801156, not in SAE Transactions.

The F101 produces 30,780 lbs of thrust with afterburner full on from its maximum sea-level airflow of 352 lbs/sec (JANE's, 2006-07, page 940.) We aim to produce the same thrust by a dry turbojet cycle (no afterburning) thereby saving much fuel in supersonic dash. Important changes to reduce subsonic fuel consumption will be presented later. For now, the main thing to be accomplished next is to ensure that the output of LP compressor 1+2 matches the flow expected by HP compressor 9.

### Flow Matching I

The object is for the output of LP compressor 1+2 to flow smoothly into the first stage of HP compressor 9. That requires some calculations. The technical data comes from the text in pages 747-748 of JANE's 1978-79 (Similar data is in pages 963-964 of JANE's 1987-88.) On page 748, core flow is “typically 260 lbs/sec.” For the JT9D-59A model, fan flow is 1,619 lbs/sec and bypass ratio is 4.9 to 1. Core flow must then be 1,619/(1+4.9)=275 lbs/sec.

Now this is a lot less than the 352 lbs/sec of the F101 fan (our stage 13.) JT9D core flow was pre-compressed by its fan and the LP compressor after the fan. The large, single-stage fan had a pressure ratio of 1.6, but all that is known about the LP compressor after the fan is that it has four stages. This is the beginning of a problem. There is no data in the open literature for the pressure ratio of the compressed air leaving JT9D′s LP compressor. It's needed so that our LP compressor 1+2 can feed the right amount of air into JT9D's HP compressor as used in our FIG. 1. The expectation is that our LP compressor 1+2 can compress the air more than JT9D's fan plus LP compressor. The compressed air's volume would shrink, and it might be possible to “stuff” 352 lbs of air per second into the HP compressor designed for 275 lbs/sec. That's why two more stages 11, 10 of compression were added behind front fan 13, 12.

### JT9D LP Compressor Pressure Ratio

Help comes from an unexpected quarter: The CF6 high bypass-ratio large turbofan engine which was the main competitor to JT9D during the 1970s and 1980s. Its LP compressor pressure ratio is unknown too, but there is enough data to compute it indirectly. Such a result will be usable to the extent that CF6 architecture approximates that of JT9D. The correspondence is pretty good. A lengthwise cutaway view of CF6-50 is on page 952 of 1987-88 JANE's. It compares well to the JT9D-20 cutaway view on page 747 of JANE's 1978-79. The main thing is that both LP compressors have three stages of little blades that slope down from half the fan diameter to the smaller diameter of the HP compressor. The LP shaft speeds are about the same, 3650 RPM for the earlier versions of JT9D (both JANE's) and 3575 RPM for the CF6-50 represented as the industrial LM5000 gas generator (Journal of Engineering for Gas Turbines and Power, 109:257, 1987.)

Every component in a turbofan affects the components after it. If we know enough of what happened at the rear of the engine, we can calculate what happened upstream. Earlier models of the CF6 offer that possibility because there was a simple change in the number of stages which had a noticeable effect on the overall pressure ratio. The earliest CF6-6D had one stage of LP compression after the fan, and 16 stages of HP compressor. The CF6-50A had three stages of LP compressor but 14 stages of HP compressor. The last two stages had been dropped. These changes resulted in different overall pressure ratios, 24.2 for −6 D and 28.6 for −50 A (from JANE's.)

The starting point is the concept of average stage pressure ratio. In an early model of the Olympus turbojet which powered the Mach 2 Concorde, average stage pressure ratio was given as 1.21:1 (SAE Paper 670865, also in SAE Transactions, Vol. 76, page 2680.) Then, with its 14-stage compressor, (1.21)¹⁴=14.4, the overall pressure ratio. We use average stage pressure ratio as an index of the performance of the CF6 compressors. The fan is deemed the first stage of LP compression, since its hub turns at the same RPM as the LP compressor blades. Average stage pressure ratio is expressed as “x” for the LP compressor and “y” for the HP compressor. Then, for these early models of CF6,
CF6-6D:ₓ²y¹⁶=24.2
CF6-50A:ₓ⁴y¹⁴=28.6.
   Next, one variable is eliminated. We square the expression for −6 D and divide by the expression for −50 A:

$$\frac{{x}^{4} {y}^{32}}{{x}^{4} {y}^{14}} = \frac{586}{28.6}$$

The x's cancel out, and so do y¹⁴s, so y¹⁸=20.48. Taking 20.48 to the power of ( 1/18) on a calculator, y=1.1826. This is a plausible result because it's slightly less than early Olympus's 1.21. The reason for a lesser value is the pre-heating by the CF6's fan and LP compressor of the air reaching CF6's 14-stage HP compressor. Olympus's 14-stage compressor experiences no such pre-heating of the intake air. The final version of Olympus 593 achieved a pressure ratio of 15.5 (JANE's, 1978-79, page 694.) CF6's HP compressor is not expected to equal that performance. Indeed y¹⁶=14.643, which is less than 15.5, and took two more stages. Solving now for “x”, using the original expression for CF6-6D, (x²)(14.643)=24.2. Then x²=1.6527 and x=1.2856. Thus, four stages of LP compression (as if it were the five stages of JT9D's LP compressor plus fan) gives (1.2856)⁴=2.7313. This estimate, here derived from a competitor's engine, is the one chosen. But the preference is to use the JT9D's core, not the CF6's. JT9D's core has a large central bore capable of housing an LP shaft large enough to be rigid against vibration from turning twice as fast in our engine as it does in JT9D. Unfortunately, the algebraic method doesn't work in JT9D. Between the two main models, the LP compressor was “completely redesigned” (JANEs 1978-79, page 747), which confounds the results.

Before proceeding to use the estimate for LP compressor exit pressure ratio=2.7313, a completely different set of calculations was performed which this time did rely on JT9D data from JANE's and the drawing of the lengthwise cross section of JT9D-59 at the bottom of page 747, 1978-79 JANE's. RPM data was used, also measurements of the various blade radii of rotation, as well as comparative cross sectional areas of the airflow vein. Since these calculations are somewhat long, they are presented in the Appendix, but their results are given here. Two different computations yield pressure ratios of 2.773 and 2.775. Since 2.7313 from CF6 is outnumbered, two-to-one, 2.773 was chosen as the pressure ratio of the air that JT9D's HP compressor expected to receive from the exit of the LP compressor.

### Flow Matching II

From pressure, density can be derived. Using the thermodynamic formula, ρ=P^{1/k}, where “ρ” is density and “k” is the ratio of specific heats, 1.40 for air near room temperature. Then 2.773^{1/1.4}=2.773^{0.7143}=2.072. Thus, the first stage of HP compressor 9 seen in FIG. 1 expected to receive air at 2.072 times atmospheric density when the compressor was still in JT9D-59. Now, when it's in our engine, HP compressor inlet air must be at greater pressure and density because of greater flow. However, F101's front fan develops a pressure ratio of 2.2 (SAE Paper 801156), not even 2.773. That's why two-stage booster 2 was added in FIG. 1. As an economy in our LP compressor development, blading in stages 11, 10 might just be shorter versions of earlier blades 12.

The air density after stage 10 needs to be higher by a factor 352 lbs per sec/275 lbs per sec=1.28 to pass that extra air. (1.28) (2.072)=2.652, the density ratio our LP compressor has to achieve. We use the backward version of the thermodynamic formula to compute the pressure ratio: P=ρ^{k}. P=2.652^{1.40}=3.918.

That's not too much to ask from the four stages of our LP compressor 10-13. For one thing, it will turn as fast as F101's fan (7710 RPM, SAE Paper 801156), not the former 3650 RPM of JT9D's. LP shaft. Secondly, some current examples suggest a trend. SAE Paper 801156 is for the F110, the F101-derivative engine used in fighter planes. Its 3-stage fan develops a pressure ratio of 3.2. It's a jump of unity from 2-stage F101 fan's 2.2. Our fourth stage, if delivering another unity jump, would give 4.2, more than enough. If not that good, then 3.918/3.2=1.224, not far above the 1.21 average stage pressure ratio in Olympus. A slight increase in RPM should suffice.

After these design decisions concerning engine configuration, the components expected to be adapted from existing turbofans are denoted by numbers 1 and 3 at the heavy arrows in FIG. 1.

### Overall Pressure Ratio

It's needed for calculating the expected engine power. Four stages of LP compression 10-13 plus eleven stages of HP compression 9 et al give a total of 15 stages. The pressure ratio of HP compressor 9 as it was in JT9D was not found in the literature. An estimate of overall pressure ratio is to compare our engine with 15 stages to a similar one whose pressure ratio is known. A good example is the F401 engine with 14 stages. The F401 is also a two-spool engine and its pressure ratio is 26.9 (JANE's, 1978-79, page 750.) 27.0:1 seems a prudent estimate for our engine, since it has one more stage.

### Engine Power

In what follows, temperature in degrees R (“Rankine”, or Fahrenheit absolute) is, as usual, ° F.+460, e.g., 70° F.=530° R. For comparing our engine to the Olympus 593 turbojet, a rough power-produced index is defined simply as the product of mass flow and the temperature rise in the combustion chamber. Olympus data is from JANE's, 1978-79, pages 694-695. The pressure ratio of 15.5 means a pressure of (15.5)(14.7 psia)=228 psia. An air compression chart gives a temperature of 1157° R, for an ideal temperature rise of 1157−530=627° F. Olympus compressor efficiency is 87.5% (SAE Paper 800732, FIG. 17, also in SAE Transactions, 89:2281, 1980.) Dividing 627° F. by 0.875 gives an actual temperature rise of 717° F., for an actual temperature of 1247° R, or 787° F. From the text, bottom left column of page 2958, SAE Transactions, Vol. 84, 1975 (SAE Paper 751056), actual Olympus 593 takeoff is at a turbine entry temperature of 1430° K (Centigrade absolute). Then T=(1.8)(1430)=2574° R, or 2114° F. The power production index is (2114° F.−787° F.)(410 lbs/sec of airflow)=544,070.

In our engine, a pressure ratio of 27.0 means a compression pressure of (27)(14.7 psi)=397 psi. From the air compression chart, ideal temperature is 1348° R. At our higher pressure ratio, compressor overall efficiency is about 83%. The ideal temperature rise was 1348−530=818° F. The actual temperature rise is 818/0.83=986° F. Actual temperature is 986+530=1516° R=1056° F. From JANE's, JT9D-59A turbine inlet temperature is 1350° C. to 1370° C. The latter is 2498° F. Our turbine entry temperature would be the same. Combustion chamber temperature rise is then 2498° F.−1056 F=1442° F. Power-produced index is (352 lbs/sec)(1442° F.)=507,742.

That is 93.32 percent of the Olympus amount. From JANE's, 1978-79 page 83, Olympus takeoff thrust with 17% afterburning is 38,050 lbs. Dry thrust is then 38,050/1.17=32,500 lbs. Our thrust would be (0.9332)(32,500)=30,330 lbs. This is 98.5% of F101 max thrust of 30,780 lbs (JANE's, 2006-07, page 940.) Including the smaller drag of slimmer nacelles in B-1 (detailed later) because no afterburner, our engine could replace F101 in B-1. Would anyone want to?

### Flight Performance

The F101 turbofan in B-1 has a bypass ratio of 2:1 and it relies on afterburning to develop its maximum thrust. From JANE's, 1978-79 page 740, dry thrust is 17,000 lbs. Afterburning therefore supplies 30,780/17,000−1=81 percent more thrust. This brings on a fuel consumption penalty. We can estimate it, using the data on Olympus fuel use with afterburner on, from SAE Paper 751056 earlier cited. On page 2946, 1975 SAE Transactions, the bottom half of the second column, it says that having reheat on at Mach 1.2 climb (FIG. 8) ups fuel consumption from 1.10 lb/lbt·hr to 1.41. A penalty of 1.41−1.10=0.31. It represents a 0.31/1.10=28.2% fuel flow increment. This is for a thrust increase of “some 30%”. Thus, the 81% added thrust from afterburning in F101 might cause a fuel flow excess of (81/30)(28.2%)=76 percent at supersonic speed.

That's the reason for considering fitting the B-1 bomber with a turbojet like the one in FIG. 1. A mission profile which includes a supersonic segment should be able to fly that segment 76 percent further for the same fuel use. Over hostile territory it might make the difference in eluding SAM sites.

Two disclaimers follow. First, the calculation based on Olympus data at Mach 1.2 and 40,000 feet might not hold at Mach 2.0 and 53,000 feet. Second, our fuel savings don't come into play except near maximum range. On short missions, it's simpler to just load more fuel. Still, one can't be sure of always having an air base near the target area.

### Subsonic Fuel Use

Here the F101 has a clear edge. Turbofan exhaust has more mass flow and less velocity than in a turbojet, so the propulsive efficiency is higher. Our engine would use more fuel in subsonic flight. We go on to Stage II of the invention. Briefly, the turbojet in FIG. 2 is shorter, to save weight, and adapted to turn a remote fan. The fan (not shown, because already knownin the art) will be driven by driveshaft 20 controlled by clutch 21.

### An Improved Embodiment

The main change in FIG. 2 is that HP section 24 is much shorter. HP compressor 23 has 6 stages, not 11, and HP turbine 25 is single-stage, not 2-stage. In other words, about half of JT9D's HP core has been removed—The inner half. This is possible because the two stages of JT9D's HP turbine approximately divided the work of turning the HP compressor. That usually maximizes the efficiency.

The remote fan (not shown) which will be driven by driveshaft 20 is seen as FIG. 10 of U.S. Pat. No. 3,161,019. It's expected that it will double the subsonic air mass flow, thereby increasing the propulsive efficiency. Unlike the remote fan in U.S. Pat. No. 3,161,019, ours would only be two stages, probably the same size as stages 19 and 18, and delivering the same pressure ratio of 2.2. In other words, it could be just the F101 fan again. Again unlike U.S. Pat. No. 3,161,019, our remote fan would not discharge into the engine's exhaust nozzle, but under the engine nacelle after a short exhaust duct. This is in co-pending application Ser. No. 13/068,583.

The first change in FIG. 2 was new clutch 21 which will disconnect driveshaft 20 from the engine when the remote fan is idle at supersonic speeds. The last change in FIG. 2 is LP turbine 26 which is now two-stage in order to drive that remote fan. Under the added load, nozzle flaps 27 open wider, decreasing the gas pressure in the exhaust. More pressure drop in LP turbine 26 powers the remote fan.

### The LP Compressor

With only four LP compressor 22 stages and six HP compressor 23 stages, the total of ten stages is far below the fourteen stages in Olympus 593 which give a pressure ratio of 15.5. On the other hand, the F101's two-stage fan, with its pressure ratio of 2.2, has an average pressure ratio of \sqrt{2.2}=1.483. This is much higher than Olympus's 1.21 previously cited. There is a hope that our fewer stages can still deliver a competitive pressure ratio. An accurate estimate of LP compressor 22 performance is needed.

All stages after the first stage compress pre-heated air, which decreases the pressure ratio of any later stage. The challenge is to understand what this pre-heat penalty might be, in order to accurately estimate the pressure ratio of each and every stage. The example of a two-stage axial compressor in SAE Paper 720712 (not in SAE Transactions) is used. From its Table 2, the first stage's presure ratio was 1.825 and the second stage's was 1.66. Their product is 3.0, the cited overall pressure ratio, so 1.66 is the actual, not the native pressure ratio of the second stage. Both stages are transonic because they both had shock losses. If the second stage was a repeat of the first, then the pressure ratio loss due to pre-heat is simply 1.825−1.66=0.165. But the first stage is a J-blade and the second stage has circular-arc contours. The second stage probably can't be compared directly to the first stage. Then the pre-heat penalty must be some other amount. We could assume a native pressure ratio of 1.7, which became common for fan blading in the late 1980's. Then the pre-heat loss factor would be 1.7−1.66=0.04. This is certainly too low. This compressor was a high performer for 1972. A better approach is to start with the average stage pressure ratio of \sqrt{3.0}=1.732. Then the second stage pressure ratio pre-heat penalty could be 1.732−1.66=0.072.

As a check on 0.072, the data in Table 1 of Journal of Engineering for Power, July 1961, page 304 is for a 5-stage transonic compressor. Stages 3, 4 and 5 show drops in pressure ratio from stage 2 of 0.055, 0.075 and 0.085. Their total is 0.215, which when divided by 3 stages gives 0.0717. This is close enough to our 0.072. We will apply that pre-heat pressure ratio loss to all later stages 18-16.

The first two stages 19, 18 of LP compressor 22 are the F101 fan. From SAE Paper 801156, its pressure ratio is 2.2:1. Average stage pressure ratio is 1.483. The first stage will be higher and the second stage will be lower. The 0.072 is divided in halves of 0.036. Each half is added to or subtracted from 1.483, giving 1.519 and 1.447. As a check, the product (1.519)(1.447)=2.198, close to 2.2. Continuing, 1.447−0.072=1.375, and 1.375−0.072=1.303. The product of all four factors, (1.519)(1.447)(1.375)(1.303)=3.938. This is the expected pressure ratio after stage 16 in FIG. 2. It slightly exceeds the 3.918 previously calculated as able to “stuff” 352 lbs/sec of air into JT9D's HP compressor, which was designed to expect 275 lbs/sec. Thus, LP compressor 22 passes that test.

### Overall Pressure Ratio

The installed pressure ratio of shortened HP compressor 23 is the other part of that. Its pressure ratio is some fraction of the installed pressure ratio of the whole compressor as in FIG. 1. The latter is easily computed. JT9D-59's overall pressure ratio of 24.0, from JANE's, was divided by our estimate of 2.773 after the LP compressor, giving 8.65. Now, in FIG. 2, we propose to keep only half of the HP compressor. Then its basic pressure ratio would be \sqrt{8.65}=2.94. The outer half which was kept, part 23, would have a higher pressure ratio than the omitted half because of less pre-heat. This must now be re-added. 2.94 is about twice the average stage pressure ratio of the F101 fan which was 1.483. Thus, two pre-heat penalties of 0.072 each should be re-added for the kept half, giving 2.94+(2)(0.072)=3.084. This is the installed pressure ratio of HP compressor 23. Overall pressure ratio is (3.938)(3.084)=12.14. Unfortunately, that is just not high enough in a modern engine. Therefore, FIG. 2 shows only a transitional design, not to be further considered. The final stage of the invention follows.

### The Preferred Embodiment

In FIG. 3, LP compressor 31 is a scaled-up version of LP compressor 22 of FIG. 2 plus one more stage 32. Whereas the diameter of stage 19 in FIG. 2 was the same as in F101 (45″), the diameter of stage 44 in FIG. 3 is 7.9% greater. The result of the enlargement is to move more air. The need for that is to counteract the consequences of the pressure ratio increase caused by fifth stage 32. Higher pressure means greater density and therefore less volume flow into HP compressor 33. The airflow angles at the blading would be wrong. Enlarging rotors 44-42 et al corrects that by restoring volume flow.

The manufacturer of F101 has experience in scaling up a multistage fan. The F110 fighter plane engine uses the F101 core but its three stage front fan is a scaled-up version (JANE's, 1987-88, page 954) of the one in the F404 turbofan. A lengthwise cross section of the F110 fan can be seen in FIG. 2 of U.S. Pat. No. 6,471,484, and all three fans together are seen in FIG. 3 of SAE Paper 801156 previously cited. Scaling up the F404 fan to F110 size increased the airflow from 142 lbs/sec to 270 (JANE's, 2006-07, page 940.) In our FIG. 3, scaling up the F101 fan is much less, now to be computed as 16.4 percent.

The new pressure ratio out of fifth stage 32 is easily calculated from the preceding stage less the pre-heat penalty: 1.303−0.072=1.231. Multiplying that to four-stage pressure ratio of 3.938 previously obtained gives 4.8476 in these five stages. More compression means greater air density, from which we can calculate the airflow increase. We again use the thermodynamic formula, ρ=P^{1/k}. New ρ=(4.8476)^{0.7143}=3.088 times atmospheric. The density ratio earlier calculated for JT9D's HP compressor inlet was 2.072, corresponding to an airflow of 275 lbs/sec. The new airflow in FIG. 3 is (3.088/2.072)(275)=409.8 lbs/sec.

That is a 16.42 percent increase over F101's 352 lbs/sec, and a 49 percent increase of the airflow into HP compressor 9 of FIG. 1 when it was in JT9D. The new pressure ratio of 4.8476 going into HP compressor 33 of FIG. 3 is 75% greater than when the HP compressor was still in JT9D. The strength of HP compressor 33 under the greater pressure is a concern. A change which would help is to use the HP compressor from PW4000, the JT9D successor with almost identical architecture (Drawing, JANE's 1998-99, page 793.) It has an overall pressure ratio of 29.7 (JANE's, 1987-88, page 963.) That is a 23.75% increase over JT9D-59's pressure ratio of 24.0. Another help is our blading drum 39 only 58% the length of the original, therefore more rigid.

### Final Overall Pressure Ratio

HP compressor 33's projected pressure ratio was calculated five paragraphs ago at 3.084. Then overall pressure ratio would be (4.8476)(3.084)=14.95. An improvement over the 12.14 with four stages. Furthermore, a favorable factor earlier left out is that our six stages of HP compressor 33 is more than half of JT9D's 11-stage HP compressor. An upward factor applies: 6/(11/2)=1.0909. Then the expected engine pressure ratio is (14.95)(1.0909)=16.3.

That exceeds the 15.5 of Olympus 593, which was designed for extended time at Mach 2. Our 16.3 is the stopping point for now.

### Engine Power

As for FIG. 1, it is computed at sea-level conditions, therefore subsonic. However, the remote fan is assumed de-clutched, ignored for the purpose of the comparison to Olympus. As before, work index depends on the temperature rise in the combustion chamber. That temperature is different now. In our FIG. 3, it's the temperature at entry to 34, the second stage of JT9D’s HP turbine, since it's the only part of that turbine that was kept. Such temperature is not given in JANE's, but overall turbine inlet and exhaust temperatures are given, 1370° C. and 482° C. (2498° F. and 900° F.) Determining the turbine inlet temperature to JT9D's HP turbine second stage starts by apportioning the overall turbine work correctly to the individual HP and LP portions. The analysis of turbine work relies on RPM data and is done by once again using the drawing of JT9D-59 on page 747 of 1978-79 JANE's.

As in the Appendix, stage work varies as “uv”, where “u” is blade speed and “v” is gas tangential speed. Analogous to the compressor situation, “v” is caused by blading curvature, of the stators this time. The more the curvature, the more the stators act like nozzles, and the higher the gas tangential speed. But curvature is fixed. We can determine u=(2π)(blade radius of rotation)(RPM). RPM=3430 for LP and 8000 for HP (JANE's, 1987-88, page 963.) Average LP turbine blade height of rotation is measured from the drawing to be 1.1 times that for HP. However, there are twice as many LP stages as HP stages. HP turbine work index is (8000)(1.0)(1.0)=8000. LP turbine work index is (3430)(1.1)(2.0)=7540.

This paragraph is thermodynamics, which may be skipped over to the last sentence. The specific heat of a gas increases with temperature, so enthalpy (“H”) keeps track of the work done by an expanding gas, and it is read off a thermodynamic chart. Between the temperature limits of 2498° F. and 900° F., the H range is 752 BTU to 248 BTU. ΔH=752−248=504 BTU. Apportioning that between HP and LP is done in proportion to the work indexes, 8000 for HP to 7540 for LP. The division point is at ΔH=259 BTU. It corresponds to H=752−259=493 BTU on the chart. That marks the end of HP turbine expansion in JT9D. Only the second of the two stages was kept in FIG. 3. Turbine work is usually evenly divided between stages. Then, at entry to HP turbine second stage, H=752−(259/2)=622.5 BTU. Finding that point on the chart reveals the temperature, which is 2556° R, or 2096° F.

That will be the temperature at exit of combustion chamber 37. The temperature at entry is the temperature at the end of HP compressor 33. There, the pressure will be (16.3)(14.7 psia)=240 psia. From the air compression chart, the ideal temperature would be 1190° R, a rise of 1190−530=660° F. With a compression efficiency of 87.5% (same as Olympus), the actual temperature rise is 660/0.875=754° F. Actual temperature after compression is 754+70=824° F. The temperature rise in the combustion chamber therefore is 2096° F.−824° F.=1272° F. The power production index, airflow times temperature rise, is (409.8 lbs/sec)(1272° F.)=521,148.

As before, it can be compared to the power production index for the Olympus 593, which was calculated earlier as 544,070, corresponding to a dry thrust of 32,500 lbs. Our engine in FIG. 3 gives (521,148/544,070)(32,500 lbs.)=31,131 lbs of thrust. This 1.1% over F101's thrust of 30,780 lbs. Our engine in FIG. 3 could replace the F101. We continue to check if it would be worthwhile.

### Subsonic Fuel Consumption

This is the other flight regime with potential fuel savings. With a remote fan, our powerplant will have an airflow of (2)(409.8 lbs/sec)=819.6 lbs/sec, compared to F101's 352 lbs/sec. Greater mass flow means less jet velocity for the same thrust, therefore higher propulsive efficiency. A comparison is made to F101 operating at maximum dry thrust, which was 17,000 lbs.

From physics, thrust is exhaust momentum, “mv” per second. “m”, in slugs, is weight flow divided by g=32.17 ft/sect. Thus, for F101 maximum thrust, (352 lbs/sec/32.17)(v)=30,780 lbs. Solving for “v” gives 2813 ft/sec. (For comparison, Olympus exhaust jet velocity at takeoff maximum thrust is 2900 ft/sec, FIG. 26 of SAE Paper 751056 previously cited.) F101 thrust of 17,000 lbs without after-burning requires an exhaust jet v=2813 ft/sec/1.81 afterburning factor=1553.66 ft/sec.

During subsonic cruise at Mach=0.8 and 35,000 ft altitude, where the speed of sound is 660 MPH, aircraft speed is 528 MPH, or 930 ft/sec. Propulsive efficiency is defined as

$$\frac{2}{1 + \frac{{v}_{exhaust}}{{v}_{aircraft}}} .$$

Thus, for the B-1 with F101, propulsive efficiency is:

$$2 / ( 1 + \frac{1553.66}{930} ) = 2 / ( 1 + 1.67 ) = 74.89 \% .$$

In our engine, the large load of the remote fan added by clutch 30 engaging will force a much greater pressure drop in 2-stage LP turbine 35, taking energy out of jet exhaust 36. The remote fan (not shown) is expected to give a pressure ratio of 2.2 (same as the F101 fan.) A textbook nozzle formula gives the ideal exhaust velocity resulting from the pressure ratio. We use equation 8.20 from “Gas Turbine Theory” cited in Appendix, with the substitution for nozzle flow of 1/nozzle efficiency for intake efficiency. In other words, taking into account the friction loss in a real nozzle as was done in equation 3.14 and the one before it. The result is a remote fan discharge velocity of 1347 ft/sec. Then remote fan thrust is (409.8 lbs/sec/32.17)(1347 ft/sec)=17,159 lbs.

This, of course, would be too high for subsonic cruise: All by itself it exceeds the 17,000 lbs thrust of F101 without afterburning at subsonic cruise. Our engine thrust, lessened by the load of the remote fan, would add another large amount. There is too much thrust at subsonic cruise. Our powerplant must be throttled ‘way down for comparison to F101's 17,000 lbs dry thrust.

The remote fan takes power from the engine of FIG. 3, so they are computed together as a unit. 17,000 lbs thrust is 54.6% of our maximum engine thrust of 31,131 lbs. FIG. 4 of SAE Paper 720758 (also in SAE Transactions, Vol. 81, 1972) is a gas turbine engine performance map. If turbine inlet temperature is held constant, 54.6% power comes at 78.5 percent RPM. FIG. 4 of SAE Paper 740166 (also in SAE Transactions, Vol. 83, 1974) plots pressure ratio against airflow at various RPM. Interpolating the constant-temperature operating line to 78.5% RPM, the airflow is 65% of the maximum value. This will apply to the remote fan too, because that blading is the same as stages 44, 43 and will turn at the same RPM.

Subsonic cruise at 54.6% power means that the total airflow through the engine plus remote fan will be (0.65)(2)(409.8 lbs/sec)=532.74 lbs/sec. Then (532.74/32.17)(v)=17,000 lbs. Solving for “v” gives 1026.6 ft/sec. Our propulsive efficiency will be:

$$2 / ( 1 + \frac{1026.6}{930} ) = 2 / ( 1 + 1.104 ) = 95.06 \% .$$

This is 0.9506/0.7489=1.269 times the subsonic propulsive efficiency of F101. However, the savings in fuel won't be quite as much. Our pressure ratio of 16.3 will drop because of reduced RPM., FIG. 13, Journal of Engineering for Power, April 1962, page 193 shows that a pressure ratio of 16.3 drops to 12.16 at 78.5% RPM. That decreases efficiency. We now compare our cycle efficiency to that of F101. From SAE Paper 801156, the pressure ratio of F101's HP compressor is 9.5. Overall pressure ratio must be (2.2)(9.5)=20.9. We estimate its turbine inlet temperature at 2240° F. for extended cruise. Our earlier computed temperature is 2096° F. The comparison uses the cycle efficiency graph, FIG. 2.18 of “Gas Turbine Theory”. The graph is extrapolated to pressure ratio of 20.9 for F101 and interpolated to 2096° F. for our engine. F101's cycle efficiency is 35.1%, and ours is 31.67%. This is 90.2 percent of F101's. Our net fuel efficiency compared to F101 would be (0.902)(1.269)=1.145 times as great, or 14.5 percent higher. Our subsonic fuel use will be less than in F101 by:

$$1 - \frac{.7489}{( .9506 ) ( .902 )} = 1 - .874 = 12.6 percent$$

Charts for subsonic cruise conditions were not found, thus for cruise power our T₃=2096° F. is too high and RPM=78.5% is too low. In a real engine, RPM and pressure ratio will be higher. The greater cycle efficiency means the fuel savings will exceed 12.6 percent.

### Engine Diameter

F101's diameter is 55.2″ (JANE's, 2006-07, page 940). From photographs, it's thickest at the rear, where the afterburner duct is. Our engine diameter at the turbines is 45.2″. This might allow slimmer engine nacelles in the B-1 with our engines. The present bulge at the rear of the nacelles can be seen on the underneath view in the 3-way drawing on page 918 of the 26 Dec. 1974 issue of “Flight International” (Call number TL501.F5.)

### HP Spool Construction

In FIG. 3, HP spool front flange 40 rises up almost vertically to attach to HP compressor second stage 41. This is a change from JT9D. It increases the separation from rear cone 38, for more rigidity.

### Appendix: JT9D-59 Compressor Pressure Ratios

First, the LP compressor pressure ratio is found; then again, and also for the HP compressor. The first method uses the JT9D-59 drawing at the bottom of page 747 in JANE's, 1978-79. The goal is to obtain the pressure ratio of the air in the flow vein after the fourth stage of the LP compressor. The method is simple and uses the Continuity Equation from Fluid Mechanics: ρAv=constant. Greek letter “ρ”=density; A=area; v=velocity. The method takes advantage of the fact that most axial-flow compressor designers prefer to keep the air velocity in the flow vein almost constant (“Gas Turbine Theory”, H. Cohen et al, 1996, page 156.) This eliminates “v” as a variable. Then the continuity equation says that the density of the air varies inversely as the area of the flow vein.

Therefore, we measure the area of the flow vein just before the fan and compare it to the area of the flow vein after the fourth, and last, stage of the LP compressor. The justification, from page 227, is “ . . . the annulus area must progressively decrease as the flow proceeds through the compressor, because of the increasing density.”

Since the flow vein tilts downward, it's easier to measure the second area at the front face of the HP compressor (9 in our FIG. 1.) The JANE's drawing was enlarged on a photocopier to double the size for accurate measurements. At each of the stations, the inner and outer radii of the flow vein are measured, then squared and times “π” for the area, then the difference taken, giving the cross-sectional area of the annular flow vein. It is found that the first area is 2.072 times the second, giving the air density ratio. In other words, a little more than twice the density of ordinary air.

From thermodynamics, P=ρ^{k}, where “k”, the ratio of specific heats, is 1.40 near room temperature. Then the desired pressure ratio is (2.072)^{1.40}=2.773. That's the pressure ratio of the partly compressed air before it entered the HP compressor.

Before settling on that value, we wish to confirm it by another, completely different method. The work of the blading as it spins rapidly in the engine's casing is the new variable.

This method uses comparisons of blade speeds. They vary quite a bit. In the JANE's drawing of JT9D-59, LP and HP compressor blades are at different radii of rotation. Also, RPM more than doubles from LP to HP. Briefly, stage work varies as “uv”, where “u” is blade speed and “v” is the tangential velocity of the air. The complete definition is on page 159 of the textbook. In any case, “v” is determined by the turning angle of the rotor blades: The more the blade curvature, the more the axial flow between stages tends to acquire the tangential velocity of the blades. Rotor blade curvature is fixed in all cases. Then “v” depends only on blade speed. “u” is the tangential velocity of the rotor blades, the only variable we have to measure.

From the drawing, it is found by measurements that LP compressor blades in stages 1-4 are at an average radius of rotation of 37 mm, while the blades in stages 1-11 of the HP compressor are at an average radius of 25.4 mm. All measurements were taken at the ⅔ heights of the blades. LP spool RPM=3750, HP spool RPM=8000. A stage work index is just (radius)(RPM). The index/100 for LP is 138.6, and that for HP is 203.2. The work ratio, average HP stage to average LP stage, is 203.2/138.6=1.468. This is a useful result. It will be used as a divider for LP compressor stage work.

First, it is noted that a pressure ratio of 1.0 is no compression. Therefore, only the decimal digits in a stage pressure ratio represent a pressure increase. These digits are the ones to adjust. JT9D overall pressure ratio was 24.0. We will present an expression for that pressure ratio as the product of the pressure ratios of the fan, the LP compressor, and the HP compressor. For that, a starting value of the average stage pressure ratio is needed. In the early Olympus, that value was 1.21:1 (Table 1, SAE Paper 670865, also in SAE Transactions, Vol. 76, page 2680, Co. 1968.) From JANE'S, the pressure ratio of JT9D]s fan is 1.6. As a first try, the whole expression is:

$$\frac{Engine}{24.0} = \frac{Fan}{1.6} \times \frac{LP Comp .}{{( 1 + \frac{0.21}{1.468} )}^{4}} \times \frac{HP Comp .}{{( 1.21 )}^{11}} .$$

The expression accounts for the LP compressor being four stages and the HP compressor being eleven stages. It is found that using 1.21 yields a final product a little less than 24.0. A good fit is obtained with 1.2167 instead of 1.21:

$$\begin{matrix}24.0 = \begin{matrix}1.6 & {( 1 + \frac{0.2167}{1.468} )}^{4} & {( 1.2167 )}^{11} .\end{matrix} \\ = \begin{matrix}( 1.6 ) & ( 1.73455 ) & ( 8.65 )\end{matrix} .\end{matrix}$$

Their product is 24.006: Close enough. The payoff is when the fan and the LP compressor are multiplied together: (1.6)(1.73455)=2.775. This should be the pressure ratio after the JT9D fan and LP compressor. It can't get much closer to the 2.773 found earlier. 2.773 is the value used in this document.

### The Wrap-Up

This document is essentially two narratives under a single cover. The first narrative is that a turbojet design can be based largely on major parts taken from different turbofan engine types. The second narrative is that the turbojet design can cut fuel use in a supersonic aircraft, also when subsonic if a remote fan is fitted.

Turbojet application in supersonic airliners is possible. FIG. 10 of U.S. Pat. No. 3,161,019 shows a remote fan usable in that setting. My co-pending application Ser. No. 13/068,583 follows up on that. Its remote fan is different from FIG. 10, with fewer stages and exhausting under the engine nacelle. Its location is different too, not in line with the engine as in FIG. 10. Instead, twin tandem fans for two engines nest in the lozenge-shaped central island formed by the diverging-converging supersonic intake flow passages. Driveshaft 46 in our FIG. 3 accommodates that arrangement by heading off at an angle such as the one shown. It would bring power to the tandem fans (included in application Ser. No. 13/068,583) whose axis of rotation, if extended backward, passes between the two engines in a nacelle.

As a result of driveshaft 46's angle, there will be a side load on the housing of clutch 30. The load will be transmitted to the fixed inlet guide vanes such as 45. They might not have to be strengthened: There are 20 of them in the photograph of F101, page 740 of JANE's, 1978-79.

A definition follows. A turbojet could be thought of as a turbo-fan with a bypass ratio of zero. Engines identified as turbofans in the various JANEs show these bypass ratios:

F110-0.87 F100-0.7 F100-PW-229-0.36 F404-0.34. In some engines, compressor bleed is used during certain flight regimes. In our engine, small continuous bleed could fine-tune the flow matching between LP and HP compressors. Thus, for our invention, “turbojet” is defined as a jet engine with a bypass ratio of zero up to 0.30. Re-injection of bleed air into the jet pipe does not count as “bypass” because it exits from the propulsion nozzle.

F101 front fan's diameter of 45″ was projected to be expanded to (1.079)(45″)=48.6″ for FIG. 3. Fans about that size in regional airliner turbofans might also be suitable. There is a 48.7″ fan in JT8D-109 (SAE Paper 730346, also in SAE Transactions, 82:1125 (1973). It could be stage 44 in FIG. 3. Then the last four stages of five-stage LP compressor 31 of FIG. 3 might just be the transplanted four stages 19-16 from FIG. 2. There isn't enough information about air flow and pressure ratio to calculate the flow match, but the outer diameter of FIG. 2's first stage 19 seems the same as second stage 43 of LP compressor 31 in FIG. 3. In other words, first stage 44 would be JT8D-109's 48.7″ fan, and the next two stages 43 and 42 would be the un-changed two-stage front fan from F101. On the other hand, the inner diameters of the blading aren't close to matching stages 44 and 43, so a new hub or disk for the JT8D-109 fan impends.

This method is presented as an alternative to scaling up the F101 fan. JT8D-109's RPM=7530, computed from the data in SAE 730346, is a fair match to F101's 7710 RPM (SAE 801156.) The new fan's air-flow of 467 lbs/sec exceeds our anticipated 409.8 lbs/sec. The new hub, which is needed anyway, can be enlarged to block some of that 467 lbs/sec. The −109 model was re-numbered to −209 (with airflow=469 lbs/sec) for the description in JANE's, 1987-88, page 962.

As an alternative, a glimpse at the future is given in Journal of Engineering for Gas Turbines and Power, 113:1, 1991. On page 5, advanced versions of the 3-stage F404 fan gave pressure ratios of “4.2 to almost 5”. If adapted to our airflow, then a 4-stage LP compressor as in our FIG. 2 might be enough.

The scope of the invention is found in the appended claims.

1. In a turbojet engine with two spools; said spools being substantially concentric and comprising a low pressure spool and a high pressure spool; said high pressure spool including high pressure compressor means and high pressure turbine means; and said high pressure spool being of a type originating as, or derived from, the high pressure spool means of first turbofan engine type installed three or more in a large subsonic transport aircraft capable of carrying 300 or more passengers across a continent or an ocean.

2. The device of claim 1 in which said low pressure spool includes low pressure compressor means and low pressure turbine means; and said low pressure compressor means including a first stage originating as, or derived from; the front fan means of second turbofan engine type; said second turbofan engine type being smaller than said first turbofan engine type and designed for aircraft carrying not more than 200 passengers in normal use.

3. The device of claim 1 in which said first turbofan engine type is a JT9D or a PW4000-series.

4. The device of claim 2 in which said second turbofan engine type is used to power a military aircraft and has a bypass ratio about 2:1 or less.

5. The device of claim 4 wherein said second turbofan engine type is an F101.

6. The device of claim 2 in which said low pressure compressor means are multi-stage; the first two stages of said low pressure compressor means originating as, or derived from, said front fan means of said second turbofan engine type.

7. The device of claim 4 in which the first two stages of said low pressure compressor means are scaled-up forms of two stages of said front fan means of said second turbofan engine type.

8. The device of claim 2 in which said low pressure compressor means are multi-stage; the second and third stages of said low pressure compressor means being the two-stage front fan means of third turbofan engine type; said third turbofan engine type being smaller than said first turbofan engine type and designed for aircraft not carrying more than 50 passengers in normal use.

9. The device of claim 8 where said first turbofan engine type is a JT9D or PW4000-series; said second turbofan engine type is the JT8D-209-series; and said third turbofan engine type is an F101.

10. The device of claim 1 in which said high pressure spool means of said first turbofan engine type has a two-stage turbine; said high pressure spool of said turbojet engine being a truncated version of said high pressure spool means; said truncated version keeping only substantially half the stages of the blading of said high pressure compressor means, and keeping only the second stage of said two-stage turbine.
